(19) United States
(12) Patent Application Publication
(10) Pub. No.: US 2012/0184046 A1
(43) Pub. Date: Jul. 19, 2012

(54) SELECTIVE BOND REDUCTION IN MICROFLUIDIC DEVICES

(76) Inventor: Micah Atkin, Glen Huntly (AU)

(21) Appl. No.: 13/499,680

(22) PCT Filed: Sep. 30, 2010
(86) PCT No.: PCT/AU2010/001283

§ 371 Date: Mar. 30, 2012

(30) Foreign Application Priority Data
Sep. 30, 2009 (US) 91247026

(51) Int. Cl. G01N 30/02; B32B 7/14; B32B 37/02; B32B 38/14; B32B 38/10

(52) U.S. Cl. 436/161; 156/277; 156/73.1; 156/272.8; 156/273.1; 156/272.2; 428/195.1; 422/70

(57) ABSTRACT

The invention overcomes the limitations described for the bonding of structured layers by providing a method for selectively reducing the bonding of materials. In its most generic form, the invention uses a bonding technique in combination with a printing method for modifying or covering at least one portion of a surface to either fully or partially prevent localised bonding. The structuring process may act upon the layers either before or after the bonding of the layers. The invention overcomes the limitations described in the application of affinity chromatography by providing a planar substrate with discrete optical detection flow cells that contain porous material and have connecting microchannels for fluid delivery and/or removal, and a method for making the same.

### CROSS REFERENCE TO RELATED APPLICATIONS

This application claims priority to U.S. provisional patent application No. 61/247,026, filed on 30 Sep. 2009, the entire contents of which are incorporated herein by reference.

### FIELD OF THE INVENTION

This invention relates generally to the manufacture of complex layered materials and devices. More particularly, the present invention relates to methods of selectively bonding two surfaces by selectively modifying or coating at least one surface prior to bonding to reduce, or prevent, the bonding in the selected areas. The field of this invention also extends to the manufacture of complex polymeric materials and devices, in particular those for use in microfluidic applications.

This invention also relates to structures, devices and methods of manufacture for optical imaging in microfluidic devices using porous material inside detection flow cells.

### BACKGROUND OF THE INVENTION

Many industries have moved to using layered materials to take advantage of the increased material characteristics and functionality provided by such composite structures. In some instances the fabrication of devices from layered materials can simplify the manufacturing process by forming 3-dimensional (3D) components by stacking and bonding multiple layers that have been machined or processed separately. In the field of microfluidics the layering of materials is particularly important to seal the microstructures.

In polymer microfluidic fabrication many of the manufacturing approaches are limited to creating 2-dimensional or 2½-dimensional structures. The most common of these approaches use either computer numerical control (CNC) micromilling, injection-moulding or hot embossing, which can generate only very limited feature complexity. The fabrication of complex 3-dimensional parts typically requires the assembly of several separately machined parts. However, these are often serial fabrication processes that have alignment challenges when assembling micro-parts which lead to further labour-intensive processes with relatively low throughput and high associated production costs.

Another recent approach to the fabrication of polymeric microfluidic devices is the stacking, aligning and bonding of several layers of thin, already fabricated films. This layered approach allows the use of relatively simple 2-dimensional manufacturing techniques (such as embossing, die cutting, and laser processing) as well as established bonding technologies to create complex three-dimensional materials or devices. Such a 3D design approach is especially suited to high-volume manufacturing using reel-to-reel processing as described recently by Mehalso (Robert Mehalso, “The Microsystems road in the USA” Mstnews, Volume 4/02, pgs 6-8 (2002)), Schuenemann et al. (Matthias Schuenemann, David Thomson, Micah Atkin, Sebastiaan Gars, Abdiraham Yussuf, Matthew Solomon, Jason Hayes, Erol Harvey, “Packaging of Disposable Chips for Bioanalytical Applications”, IEEE Electronic Components & Technology Conference, Nevada, USA 2004), and WO 2007/085043.

In polymer microfluidics, bonding represents a particularly difficult problem due to the requirements of maintaining the integrity of the microstructures while forming a good seal.

Bonding techniques may be broadly classified into two categories; Area bonding in which the entire surfaces of two substrates are bonded together, and Selective bonding in which selective regions on the surfaces are bonded together. Both techniques may be applied to microfluidic bonding. Typically selective bonding is the more expensive technique to implement in production but the spatial control of the bonding seal may be greater, reducing the risk of interfering with microstructures.

Adhesive bonding is typically the most common method used in polymer microfluidics. This method requires another material to act as a linker to bond two surfaces together. Typical adhesives include: cyanoacrylates, silicones, epoxies, and acrylic based materials. In manufacturing setting adhesives can be easily coated over an entire surface by sprays, wire bars, doctor blades, rollers, or laid down as a sheet or tape. Furthermore the lifetime performance, toxicity and surface interactions are all important considerations particularly for microfluidic devices in which the surface to volume ratios are so large. These are often causes of failure in these devices where the adhesive is exposed to the microfluidic channel. Therefore in many microfluidic applications it is critical to choose a compatible adhesive or enable selective adhesive control. A limited set of adhesives can be selectively deposited by printing techniques, such as the use of hot melt adhesive, or with patterned adhesive sheets or tapes. However it can be difficult to selectively deposit adhesives in a volume manufacturing setting due the select availability of suitable adhesives and deposition techniques. Some of the many issues include the adhesive viscosity requirement, the adhesive's lifetime prior to bonding, speed of deposition and deposition control.

The Diffusion method is also commonly employed in polymer microfluidics as it requires does not require the addition of any chemicals that might adversely impact device performance. U.S. Pat. No. 5,882,465 describes such a method whilst bonding under vacuum pressure to reduce the chance of bubble formation. This common batch-based technique involves applying pressure and temperature whilst bringing the substrate surfaces together and allowing time for the molecular chains from each material to slowly diffuse into one another. Typically this requires similar materials having molecular chains with sufficient mobility. Although many layers can be bonded at once care needs to be taken with voids weakening bonding layers and the applied pressures deforming structures. From a manufacturing view the process requires relatively long processing times which limits the throughput capability.

Surface modification by techniques such Plasma, corona, or UV assisted bonding have been described in the literature and they involve changing the surface chemical groups to improve bonding. Typically the exposure of a polymer in an oxygen atmosphere by one of these techniques can lead to an increase in the surface oxygen groups, which increases the surface energy and enhances bonding for many substrates. Other gases and liquids on the surface can be exposure to produce other functional surface groups. Many of the reaction pathways created by these exposure techniques involve unstable free radical species. However the suitability of these techniques has only been demonstrated for a few materials.

In limited cases selective bonding can been achieved by surface modification if masking techniques are used, ensuring the exposed areas are limited to the bonding areas. However this can be difficult to implement in a high speed production environment and still maintain the tight tolerances required for microstructured devices.

Solvent assisted bonding uses solvents to swell the polymer surfaces and increase the chain mobility to allow the two surfaces to diffuse into one another. Generally the main problem with this technique is the difficulty of handling the solvents in the production environment. Furthermore, for fluidic devices the solvent residues can provide a source of contamination, and the solvent may deform the microstructures. A process for combining a weak solvent with heat activated bonding is described in US Patent Application 2008178987.

Transmission laser welding operates by one material being transparent to and the other material being an absorber to the irradiated laser wavelength. This allows the laser beam to selectively heat between the two materials producing localised welding when the heat goes above the glass transition temperature. For integration into the production environment, the main limitations are processing times, and limitation of compatible materials and number of layers that can be processed.

Reverse conduction welding operates in a similar manner to transmission layer welding except that the heat is generated by laser absorption at a backplane. The polymer films clamped above the absorbing layer conduct the heat from its surface and locally melt. Due to the uniform heat conduction within the polymers which limits spatial resolution, the technique is only suitable for thin films and relatively large structures.

High frequency or dielectric heating is a technique that can bond polar materials by passing an AC current through them. This method can be effective for bonding materials that would normally degrade near their softening point. This is because the heat is generated uniformly in the material rather than at the surface and then conducted inwards. However for microstructures, this can introduce problems due the non specific heating causing deformation.

Ultrasonic welding depends on vibration energy being transmitted through the materials. At the interface of the two materials the vibrationary energy is translated into heat. Features can be used to focus the energy, and with careful energy control and geometry design around structured parts a good seal can be achieved without deforming the remaining material. Due to these geometric constraints for bonding, ultrasonic sealing is limited in terms of its application to microfluidics.

The deposition of specific energy absorbing materials in the proximity of the join can be also be used to induce localised melting and therefore selective bonding when irradiated by the appropriate energy sources. Energy absorbers include thin film metals, Clearweld™, polyaniline, polypyrrole, polyalkylthiophenes, metallic nanoparticles, magnetic and paramagnetic particles and other appropriately doped materials. Energy sources include electromagnetic, Microwave, UV/Visible, and Infrared radiation. For sealing microstructures the effectiveness is typically dependant limited by the deposition technique and evenly controlling the energy absorbed.

Lamination is a popular technique for joining plastic films by bringing the materials together with one or more of the films having an adhesion layer. This adhesion layer may be an adhesive as described above, or a polymer with a lower glass transition temperature that will flow under temperature and pressure to bond to the other surface. These methods are widely used in the printing and packaging industries on reel to reel systems and have been applied to microfluidic devices (A. Schwarz F. Bianchi R. Ferrigno F. Reymond H. H. Girault J. S. Rossier, Microchannels Networks for Electrophoresis Separations, 20 Electrophoresis. 727(1999)). In similar manner the lamination of layers where at least one of those layers is an adhesive layer (such as a pressure sensitive adhesive) is commonly used in microfluidics (Robert Mehalso, “The Microsystems road in the USA” Mstnews, Volume 4/02, pgs 6-8 (2002)). However these lamination methods are area bonding techniques that bond all the surfaces which are in contact. For many microstructures in polymeric devices this is further complicated by the deformation of the structure during the bonding process. If adjacent surfaces are in contact during the applied pressure then a bond may form. The use of adhesive tapes for microfluidics is further complicated by chemical or biochemical incompatibility with many assays, and the dimensional limitations provided by the machining processes of these tapes.

Lamination and other area bonding techniques are advantageous to simplify manufacturing, allowing both speed and cost improvements (WO 2007/085043, the entire contents of which are incorporated herein by reference). However, with all these area bonding techniques a problem arises where a bond is not required, or required at a different strength, in a selective area between two surfaces in contact with one another. In many cases selective bonding is not an option due to material compatibility, cost, speed and dimensional constraints. What is needed for microfluidic production is a technique that allows the selective deactivation of surfaces that is compatible with bonding techniques suitable for mass production.

The demand for rapid and easy to operate point of care in-vitro assays continues to rapidly grow. The major need is for rapid, simple (preferably single-step) reliable assays that detect specific analytes and can be easily performed outside of the laboratory setting, be it by patients at home, in the doctor's office, or at any remote location.

“Dipstick,” lateral flow,” and “flow through” format systems are typical point of care systems in use today. They are designed for rapid on-site detection of various analytes. The dipstick type of assays and devices are exemplified in U.S. Pat. Nos. 4,059,407; 5,275,785; 5,504,013; 5,602,040; 5,622,871; and 5,656,503.

A dipstick point of care device typically consists of a strip of porous material made up of three contiguous parts—a sample receiving end, a reagent zone, and a reaction zone. Different materials, usually porous, are used for the different zones, but are typically combined to form a single strip or dipstick.

Either the liquid sample is applied to the sample zone, or the sample zone is dipped into the liquid sample. The liquid sample then wicks along the porous strip into the reagent zone where the analyte binds to a reagent, already pre-incorporated into the strip in the reagent zone, thus forming a complex. The complex is usually either an antibody/antigen pair or a receptor/ligand that creates a label. The labeled complex continues its wicked migration into the reaction zone where the complex binds to another specific binding partner and is immobilized. The result provides some kind of visual readout.

Typically lateral flow devices use porous material with a linear construction similar to that of dipsticks, incorporating the three sample, reagent release zone and reaction zones. Rather than vertically wicking the sample up the dipstick, lateral flow devices flow across the porous material. Examples of assays and devices using the lateral flow format can be found in U.S. Pat. Nos. 4,943,522, 5,075,078; 5,096,837; 5,229,073; 5,354,692; 6,316,205; and 6,368,876, the contents of which are incorporated herein by reference.

Similar components are sometimes often in both flow-through and lateral flow devices. The key difference is the components in such a flow through device, which are stacked one on top of the other to enable a unilateral downward flow. In most cases in such a flow-through device, the sample application pad sits over and in direct contact the conjugate pad, which sits on the analytical membrane, under which lies an absorbent pad.

In other examples of flow through assays the fluid is gravity fed through a column of frits with separator porous elements and optical analysis, WO 2008/145722. As with other afore mentioned lateral and vertical flow devices the effect of capillary action or gravity driven flow is limited to relatively simple protocols as multiple flows from different sources and complex flow profiles, such as backwashing, are not feasible.

As can be seen from the above descriptions of typical analyte detection devices, the sample receiving area, reagent area, reaction area or analytical membrane, and the absorbant material may be all made from porous materials, such as porous polymeric materials. Limitations of such systems include the reliance on capillary or gravity flow for fluid movement, which inherently causes reproducibility issues with regards to flow rate and limitations in terms of suitability of assay protocols. These capillary and gravity flow devices are limited in terms of performing only simple one-step assays; they provide imprecise handling of fluid volumes which affects the overall reproducibility; they are restricted in terms of the maximum volume they can use and therefore limits the sensitivity; they are susceptible to matrix effects obstructing pores; and they typically provide a qualitative or semi-quantitative response [Analytical and Bioanalytical Chemistry, Volume 393, Number 2, January 2009, pp. 569-582(14)].

Microfluidics techniques have been developed that provide accurate control of flow in small structures. These developments have been brought about by the advantages that miniaturization has to offer. In particular, performance improvements can be achieved over traditional laboratory equipment in terms of automation, reproducibility, speed, cost and size. This rapidly growing field includes micro total analytical systems (μTAS), or “lab on a chip” devices. Much of this early work was performed on silicon or glass substrates using established techniques developed in the 70's and 80's for the semiconductor industries. There have been many different pumping and valving strategies that have been integrated into miniaturized devices.

Critical to the usability of microfluidic devices in many applications is the ability to analyze the characteristics of the fluids contained within the microstructures. Optical detection strategies remain one of the most common methods used to measure these characteristics in microfluidic devices. Such optical detection strategies encompass absorption, transmission and luminescence (commonly chemiluminescence and fluorescence) based measurements.

Most of these difficulties in optical measurement within microstructures arise from the tight dimensional constraints, reduced path lengths, and reduced fluid volumes leading to much smaller signal responses. Methods to increase sensitivity and dynamic range often involve increasing the amount of sample volume and or the amount reporter reagent. A porous solid phase gives a relatively high surface area for binding in comparison to binding to the walls of a capillary, well, or chamber in a microfluidic device. Such porous materials are typically used to bind the analytes of interest and allow removal of unwanted reagents in affinity chromatography, such as with immunoassays and DNA hybridisation.

One of the advantages of microfluidics is that the smaller volumes of fluid typically result in a speed improvement in detection due to the reduction in distance between the analyte in solution and the sensor surface. However a problematic aspect of microfluidic device manufacture is the increase in cost associated with the manufacturing processes required to achieve smaller dimensions and their associated tolerances. Polymers have been used as a cheaper alternative to glass and silicon for manufacturing consumable devices, especially since the 1940's and have been used for mass producing complex materials and devices for instrumentation since the early to mid 1990's. However for polymer device fabrication it is generally known that as the dimensions of a feature on a device decreases in size and the tolerance required, the cost and difficulty in implementing in a mass manufacturing environment increases greatly. This is particularly problematic in microfluidics where the tolerance requirements are often much less than 100 micron. Examples of manufacturing methods for feature formation in microfluidic devices can be generally classified into two categories. The first is using direct machining methods in which the pattern of desired features is created directly on the surface of a stratum made of a suitable material. These methods include micromilling, laser based lithography and beam scanning, plasma etching, wet chemical UV lithography using photoresists, soft lithography, x-ray lithography and print-head deposition. The second methodology involves processes that use a master template to form the desired pattern. These feature replication processes include, soft lithography, stamping, embossing, compression molding, thermoforming, injection molding and reaction injection molding.

This invention combines the fluid manipulating advantages of microfluidics with porous structures for improved methods of detection in affinity chromatography with a method that is cost effective for mass manufacturing.

All of the processes described above are applicable to the process according to the present invention described herein.

The reference to any prior art in this specification is not, and should not be taken as, an acknowledgement or any form of suggestion that the prior art forms part of the common general knowledge.

### SUMMARY OF THE INVENTION

This invention relates generally to the manufacture of complex layered materials and devices, and in particular to the manufacture of microfluidic devices. The invention overcomes the limitations described for the bonding of structured layers by providing a method for selectively reducing the bonding of materials.

A bond-reducing material is used to either fully or partially prevent a bond forming in a spatially defined location, and may be used improve the surface characteristics in a microstructure.

In one aspect, the present invention provides a method for forming a spatially defined bond between a first surface and a second surface, the method comprising the steps of (i) printing a bond-reducing material to an area on the first surface, and (ii) contacting the first surface and the second surface under conditions allowing the first surface to bond to the second surface, wherein the bond-reducing material substantially prevents or otherwise interferes with the formation of a bond between the first surface and the second surface about the area to which the bond-reducing material is applied, wherein the structure resulting from bonding first surface and the second surface is a microfluidic device.

In one embodiment, the bond-reducing material is printed by a process selected from the group consisting of: Microspotting (contact or non-contact); Contact printing; Screen printing; Syringe or ink-jet delivery; Lithography; robotic placement of dried or liquid chemicals; Letterpress, Gravure, flexographic and other such printing methods; contact mask based deposition methods; Laser based deposition or surface modification techniques; and thermal transfer methods, such as with laser, hot stamping, and thermal ribbon printers.

In one embodiment, the bond-reducing material is selected from the group consisting of an ink: A) Colorants (including pigments, toners, and dyes) that provide colour contrast. B) Vehicles, or varnishes, that bind to the printed surface and may act as carriers for any colorants during the printing operation. C) Additives that influence the printability, film characteristics, drying speed, or end-use properties, such as the inclusion of chemical moieties for bond reduction. D) Solvents, which may help in formation of the vehicles, in reducing ink viscosity, adjusting drying properties, or resin compatibility.

In one embodiment, the bond-reducing material is a solid film or foil, powder, high-viscosity paste, gel, or a low-viscosity liquid.

In one embodiment, the first surface is bonded to the second surface by a method selected from the group consisting of laser welding, diffusion bonding, surface modified chemical bonding, solvent assisted bonding, thermal laminating, chemical covalent or charged surface group bonding, mechanical interlocking, ultrasonic welding, die-electric bonding, microwave bonding, electrostatic or magnetic attraction, and adhesive bonding.

In one embodiment, the bond-reducing material is at least partially removed by a method selected from the group consisting of evaporation, absorption, chemical reaction or the application of mechanical force, air or liquid pressure.

In one embodiment, a composite structure formed by the spatially-selective bonding a first structure to a second structure, the composite structure having in one area a cross-sectional arrangement comprising the first structure, a bond-reducing material, and the second structure; and in another area the first structure, a bond-forming material and the second structure.

In a further aspect, the present invention provides a composite structure wherein the first structure or the second structure are materials selected from the group consisting of: polyolefin; Cyclo Olefin Polymer; polypropylene; polyethylene; low density polyethylene; high density polyethylene; polymethyl-methacrylate; polycarbonate; polyethylene terephthalate; polyethylene terephtalate glycol; polybutylene terephtalate; polystyrene; polyimide; polyetherimide; acrylonitrile butadiene styrene; polyurethane; polydimethylsiloxane; cellulose acetate; polyamide; polyether ether ketone; polyvinylchloride; polyvinylidene chloride; polyvinylidene fluoride; polymethylpentene; polysulfone; polytetrafluoroethylene; polyoxide methylene; nitrocellulose, nylons, acrylics, acetates, polyacrylamides, latex or silica particles, glass fibres or combinations thereof.

In one embodiment, the composite structure is produced by a method described herein.

In a further aspect the present invention provides a microfluidic device comprising a composite structure described herein.

In a further aspect the present invention provides a substantially planar microfluidic device for the affinity chromotographic analysis of a liquid analyte, the device comprising a substantially larger detection flow cell than the connecting microfluidic channels, the detection flow cell disposed substantially perpendicular to the plane of the device, the flow cell comprising (i) a liquid entry aperture (ii) a porous region and (iii) a liquid exit aperture, wherein in use the analyte flows from the liquid entry aperture, through the porous region and exits the flow cell via the liquid exit aperture.

In one embodiment the substantially larger detection flow cell is disposed at an angle of about 45, 50, 55, 60, 65, 70, 75, 80, 85, or 90 degrees relative to the plane of the device.

In one embodiment, the substantially larger detection flow cell is disposed at an angle of about 90 degrees relative to the plane of the device.

In one embodiment, the detection flow cell is capable of sustaining a maximum flow rate of 1000 micro litres per minute.

In one embodiment, the detection flow cell has a length of 10 micron to 10 millimetres.

In one embodiment, the detection flow cell has a width of 100 micron to 10 millimetres.

In one embodiment, the detection flow cell is substantially of cylindrical or rectangular shaped.

In one embodiment, the detection flow cell comprises a polymer frit.

In one embodiment, the detection flow cell comprises an affinity ligand.

In one embodiment, the detection flow cell comprises an affinity chromatographic resin.

In one embodiment, the device having a size and detection flow cell layout compatible with standard microtiter plate based systems.

In one embodiment, the device having a multi-layer laminate comprising microfluidic structures.

In one embodiment a device substantially as described in the drawings

In a further aspect the present invention a microfluidic affinity chromatographic method is provided, the method comprising (i) introducing an analyte into the detection flow cell of a device according to any one of claims 12 to 21 under conditions allowing the binding of a target molecule in the analyte to an affinity ligand and (ii) detecting the presence or absence of a bound target molecule.

### BRIEF DESCRIPTION OF DRAWINGS

FIGS. 1a and 1b illustrates a bond-reducing material coated onto one substrate prior to and after bonding. FIGS. 1c and 1d illustrate a bond-reducing material coated onto two interfacing substrates prior to and after bonding.

FIG. 2 illustrates a bond-reducing material reducing the energy density of the impinging laser radiation.

FIG. 3 illustrates a bond-reducing material altering the charges at an interface surface.

FIGS. 4a and 4b illustrates a bond-reducing material containing magnetic properties with and without an applied magnetic field.

FIG. 5 shows the bond-reducing material coating the top and bottom surfaces of microfluidic structures.

FIG. 6 shows the bond-reducing material patterned along the bond edges of the microfluidic structures.

FIG. 7 illustrates a burst valve with two deforming layers.

FIG. 8 illustrates a burst valve with one deforming layers.

FIG. 9 illustrates a check or one-way valve.

FIG. 10 illustrates a plan view of a check or one-way valve.

FIG. 11 illustrates a cross section of a check or one-way valve.

FIG. 12 illustrates a cross section of a pump structure.

FIG. 13 illustrates an implementation of a peristaltic type pump.

FIG. 14 illustrates a cross section of a filter structure disposed between two microchannels with protective bond-reducing layers.

FIG. 15 illustrates examples of light paths through the porous material.

FIG. 16 illustrates examples of source and detector configurations for analysing the detector flow cells.

FIG. 17 illustrates an example of the direction of flow through the porous material.

FIG. 18 depicts series, parallel and independent microfluidic connection of microchannels with the detection flow cells.

FIG. 19 illustrates the cross section of a porous material in a substrate and sealing layers.

FIG. 20 illustrates and example of a pneumatic distribution inside a card.

FIG. 21 illustrates an analysis card one way check valves.

FIG. 22 illustrates an analysis card with Flow control flow control valves.

FIG. 23 is a schematic representation of valve control channel requirements.

FIG. 24 a test card with detection cells arranged in series sharing five common reservoirs.

FIG. 25 a test card with two groups of detection cells arranged in parallel each with a separate reservoir and four common reservoirs.

FIG. 26 illustrates a microfluidic card with 24 detection flow cells.

### DETAILED DESCRIPTION OF THE INVENTION

It is convenient to describe the invention herein in relation to particularly preferred embodiments relating to microfluidic devices. However, the invention is applicable to a wide range of situations and products and it is to be appreciated that other constructions and arrangements are also considered as falling within the scope of the invention. Various modifications, alterations, variations and or additions to the construction and arrangements described herein are also considered as falling within the ambit and scope of the present invention.

The invention overcomes the limitations described for the bonding of structured layers by providing a method for selectively reducing the bonding of materials. In the context of this invention a bond-reducing material is defined as a material that is used to reduce the strength of a bond between two surfaces, or prevent a bond that would have otherwise occurred between two surfaces. The bond reducing material may be applied prior to or during the bonding process. In its most generic form, the invention uses a bonding technique in combination with a printing method to modify or cover at least one portion of a surface with a bond-reducing material to either fully or partially prevent localised bonding. The structuring process may act upon the layers either before or after the bonding of the layers.

The advantages of this invention for the bonding of microfluidics are numerous. Firstly it provides a simplified manufacturing method suitable for high-throughput production. It also enables a greater spatial control over the bonding process by using known printing methods to provide controlled bonding areas. There is also the added advantage that numerous spatial and area bonding techniques can be used that would otherwise be unsuitable due to their spatial resolutions or incompatibility with the microfluidic application.

The function of the bond-reducing material is to either fully or partially prevent the bond forming in a spatially defined location and or improve the surface characteristics in a microstructure. The bond-reducing material may effect either a permanent change in the surface, or a transient change that is present during the bonding process. In one embodiment the bond-reducing material comprises a permanent coating. In another embodiment bond-reducing material comprises a transient volatile component, or non-volatile component that is physically removed after the bonding process. In one embodiment the removal of the transient component occurs by evaporation, absorption, chemical reaction or the application of mechanical force, air or liquid pressure either during manufacture or during the operation of the device.

In one embodiment the bond-reducing material comprises one or more ink components, such as A) Colorants (including pigments, toners, and dyes) that provide colour contrast. B) Vehicles, or varnishes, that bind to the printed surface and may act as carriers for any colorants during the printing operation. C) Additives that influence the printability, film characteristics, drying speed, or end-use properties, such as the inclusion of chemical moieties for bond reduction. D) Solvents, which may help in formation of the vehicles, in reducing ink viscosity, adjusting drying properties, or resin compatibility. The bond-reducing material may be a solid film or foil, powder, high-viscosity paste, gel, or a low-viscosity liquid. The various drying, curing or attachment methods may include heating, oxidizing, UV cross-linking, evaporating, penetrating, precipitating, polymerizing, reactive, including radiation-cured, gelling, cold-setting or quick-setting, and thermosetting.

In a preferred embodiment of the invention, the bond-reducing material is selectively deposited by a printing technique. Such printing techniques include, but are not limited to;
Microspotting (contact or non-contact)
Contact printing
Screen printing
Syringe or ink-jet delivery
Lithography
Robotic placement of dried or liquid chemicals
Letterpress, Gravure, flexographic and other such printing methods.
Contact mask based deposition methods
Laser based deposition or surface modification techniques
Thermal transfer methods, such as with laser, hot stamping, and thermal ribbon printers

The mechanism of bond reduction, or controlled bonding, is dependant on the particular bonding method used. Such methods may include, but are not limited to, laser welding, diffusion bonding, surface modified chemical bonding, solvent assisted bonding, thermal laminating, chemical covalent or charged surface group bonding, mechanical interlocking, ultrasonic welding, die-electric bonding, microwave bonding, electrostatic or magnetic attraction, and adhesive bonding. In diffusion based bonding the printed layer acts as a full or partial barrier layer preventing the inter diffusion of molecules between the layers to be bonded. Similarly in chemical bonding or mechanical interlocking from localised melting, such as with solvent, laser, ultrasonic, die-electric, microwave, and laminating bonding methods, the printed layer may also act as barrier layer preventing portions of the two bonding surfaces from coming into contact. Alternatively the printed layer imparts a different chemical aspect to the proximal surfaces altering the bonding strength.

In a preferred embodiment of the invention at least one of the layers to be bonded comprises a polymer, such as a: polyolefin; Cyclo Olefin Polymer; polypropylene; polyethylene; low density polyethylene; high density polyethylene; polymethyl-methacrylate; polycarbonate; polyethylene terephthalate; polyethylene terephtalate glycol; polybutylene terephtalate; polystyrene; polyimide; polyetherimide; acrylonitrile butadiene styrene; polyurethane; polydimethylsiloxane; cellulose acetate; polyamide; polyether ether ketone; polyvinylchloride; polyvinylidene chloride; polyvinylidene fluoride; polymethylpentene; polysulfone; polytetrafluoroethylene; polyoxide methylene; nitrocellulose, nylons, acrylics, acetates, polyacrylamides, latex or silica particles, glass fibres resins or combinations thereof.

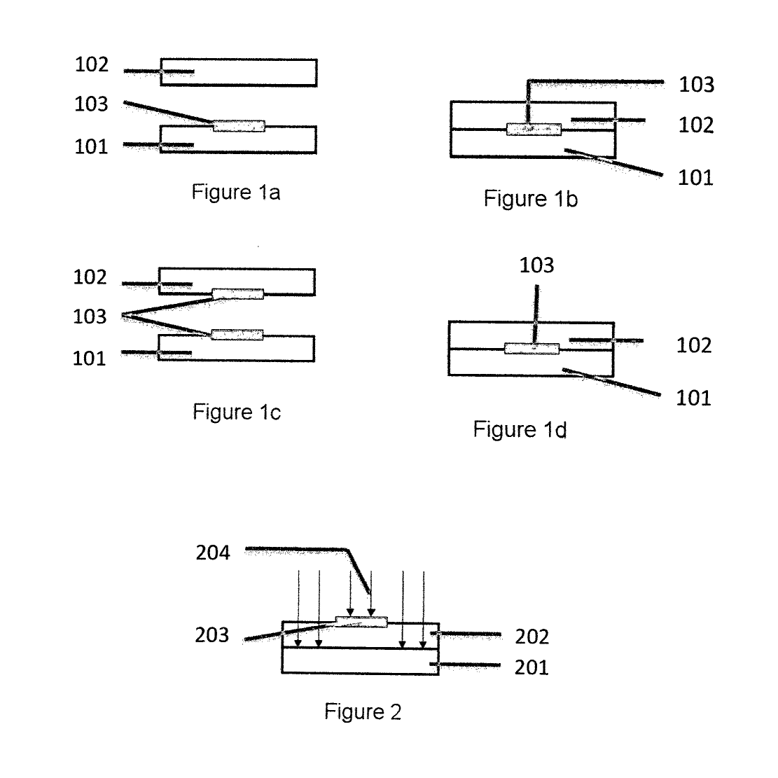

In one embodiment the printed bond-reducing layer is located on only one surface prior to bonding. For example in FIGS. 1a) and b) the bond-reducing layer 103 is located on only one surface 101 prior to bonding to the surface, 102 as shown in FIG. 1a) before bonding and FIG. 1b) after bonding. In aniternative embodiment the printed layer may be located on both adjacent surfaces. For example FIGS. 1c) and d) the bond reducing layers 103 are located on the surfaces 101 and 102, as shown in FIG. 1c) before bonding and FIG. 1d) after bonding.

In another embodiment of the invention the printed bond-reducing layer is on a nearby surface but not be in direct contact with the bonding area, and acts to reduce the bonding process in a region of the bonding surfaces. For example in laser welding the printed layer may act as a mask effectively shielding the region of interest, either partially or fully, from the laser beam. FIG. 2 illustrates two layers bonded by laser irradiation. The printed layer 204 may or may not be in directly in contact with the surfaces affected by the bonding process at the interface of 201 and 202 layers. The printed layer either partially or fully reflects, absorbs, or diffuses the laser energy resulting in a reduced bond at the interface covered by the printed layer.

In another embodiment of the invention the bond-reducing material may impart or change aspects of the electrostatic or magnetic characteristics of the surface to effect a change in bond strength.

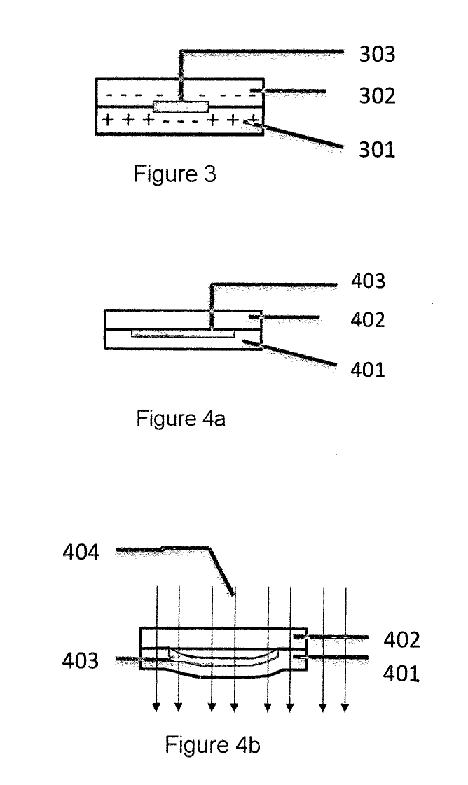

In one embodiment the bond-reducing material changes the electrostatic properties of the surface to effect a change in bond strength. FIG. 3 depicts the adjacent surfaces of layers 301, 302 in contact with one another that are oppositely charged and contribute to the bond strength, except where the printed layer 303 provides a charge contributing to a repellent force thereby reducing the bond strength in that area. The magnitude of the electrostatic force (F) can be calculated by Coulomb's Law where the Force applied on a charge (q₁) due to the presence of a second charge (q₂), is given by

$$F = {k}_{e} \frac{{q}_{1} {q}_{2}}{{r}^{2 }}$$

Where r is the distance between the two charges and kₑ a proportionality constant, which is equal to approximately 9×10⁹ Nm²/C². A positive force implies a repulsive interaction, while a negative force implies an attractive interaction.

In another embodiment the bond-reducing material comprises magnetic, ferromagnetic or paramagnetic properties which can actively be used to effect a change in bond strength. An example is illustrated in FIGS. 4A and 4B without and with an applied magnetic field 404. Where there is a printed layer 403 of material with magnetic or paramagnetic properties interface between layers 401 and 402. The mechanical force that can be applied to a coated surface can be increase or decreased according to the following equation.

$$F = \frac{{μ}_{0} {H}^{2} A}{2} = \frac{{B}^{2} A}{2 {μ}_{0}}$$

Where A is the area of each surface, in m²; H is their magnetizing field, in A/m; μ₀ is the permeability of space, which equals 4π×10⁻⁷ T·m/A; and B is the flux density, in T.

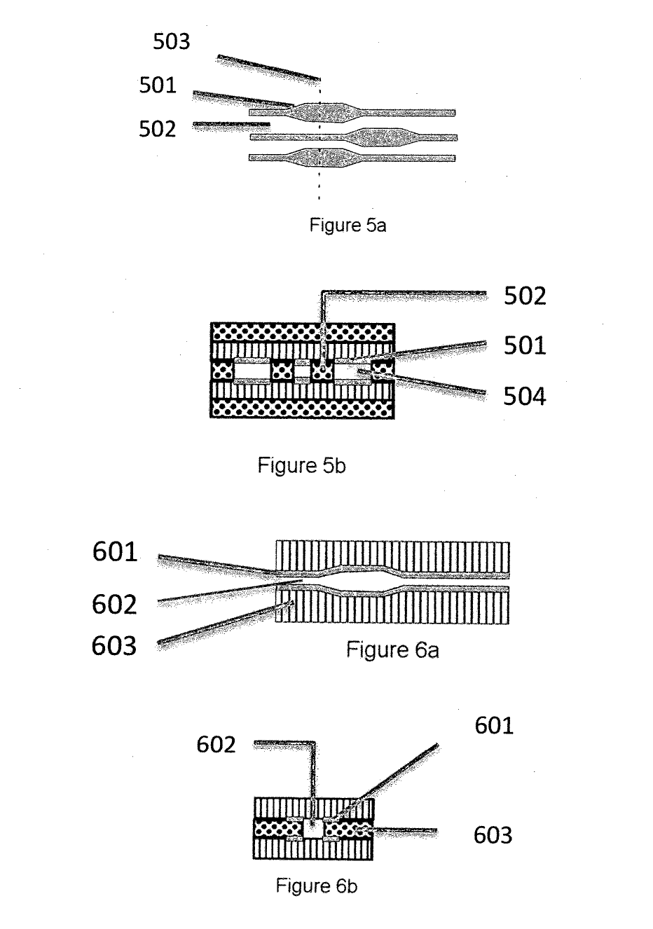

The bond-reducing material can extend beyond the interface of the bonding surfaces. In another embodiment of the invention the printed deposition of the bond-reducing material extends beyond the bonded area between two surfaces to provide an interface coating between the coated surface and the microfluidic structure. This is particularly advantages where the adhesive layer would otherwise provide one of the microstructure surfaces and cause detrimental surface characteristics in microfluidic applications. Such advantages gained may include altering the surface toxicity, wettability, non-specific binding, topology, transparency or refractive index properties. FIGS. 5a and 5b illustrate the plan and cross section views, respectively, with 503 indicating where the cross section view of FIG. 5b is taken from FIG. 5a. The parallel microchannels 504 shown have a bond-reducing material 501 printed on the top and bottom surfaces in the microchannels 504 and not between the solid surfaces 502.

The invention is particularly advantages for area bonding methods such as diffusion, surface modified, solvent, and thermal laminating to avoid bonding of adjacent layers both inside and near the microstructures. Similarly the resolution of selective bonding techniques can be improved by using such printing layers. The table directly below describes the approximate resolutions and printed material thicknesses obtainable from current reel-to-reel printing methods.

TABLE
Resolution of Reel-to-Reel Printing Techniques

[symbol]

| | Minimum | Average |
|---|---|---|
| | Lateral | Dry Film |
| Printing Technology | Resolution μm | Thickness μm |
| Gravure | 15 | 0.8-8 |
| Flexo | 20 | 0.8-2.5 |
| Offset | 15 | 0.5-2 |
| Screen | 50 | 3-35 |
| Inkjet | 50 | 0.3-10 |
| Micro-dispensing | 50 | 5-100 |
| Laser Assessed Forward Transfer | 10 | 0.01-1 |
| Electro Static | 30 | 1-10 |

[symbol]

indicates data missing or illegible when filed

In cases where the microstructures may be deformed during the manufacturing process, then the bond-reducing material can be used to prevent adhesion, and therefore prevent permanent deformation of the microstructures. For example, it is often problematic sealing a microchannel or chamber structure with a thin polymer layer (sheet, film or laminate) where the channel width is greater than the channels height without causing deformation during bonding process. Such problematic bonding processes include thermal diffusion and lamination through a roller nip. Where the channel widths and pressures are large enough then substantial deformation may occur and the opposing surfaces of the microchannel may come into contact. By coating the top and/or bottom of these structures (an example of which is shown in FIG. 5) a permanent bond can be prevented from forming if the top and bottom surfaces of the microstructure come into contact.

In one embodiment the bond-reducing layer provides an outline of the microfluidic channel proximal to the bond edge. FIGS. 6a and 6b represents plan and side views respectively of the printed layer 601 outlining the channel structure 602 along the bond edge of the substrate 603. This is particularly useful to improve the tolerances of standard bonding techniques to ensure the chemical and structural integrity of the microchannels.

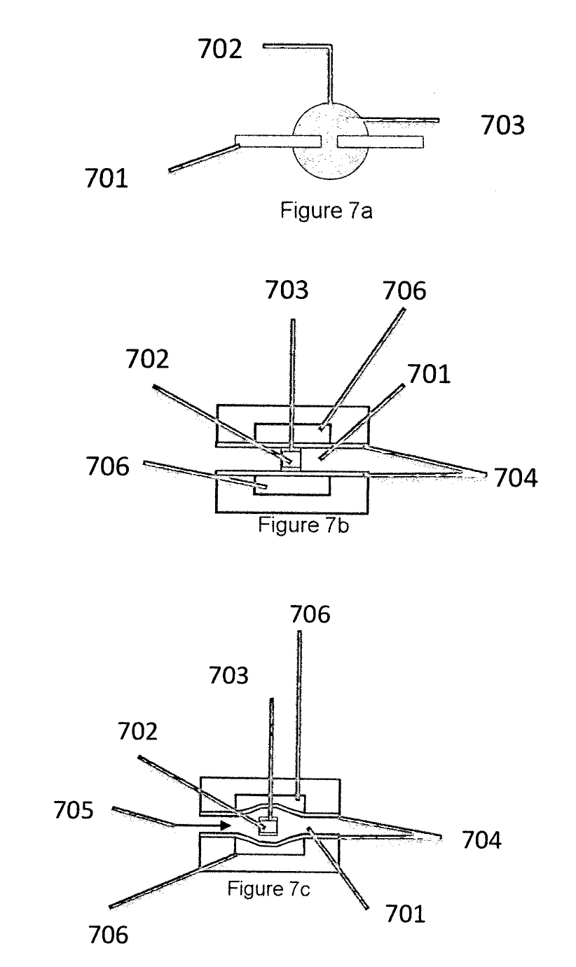

In another embodiment a pressure relief or burst valve comprises a bond-reducing material. FIG. 7a represents the plan view of a channel 701 separated by a wall segment 702 with the bond-reducing material 703 printed to avoid bonding of the wall segment 702. FIG. 7b shows the side view perspective when the valve is closed and the deformable layers 704 are in contact with the wall structure 702 having the printed layer 703. FIG. 7c illustrates what happens to this structure under an applied force 705 such that the top and bottom deformable layers 704 can deform into the cavities 706.

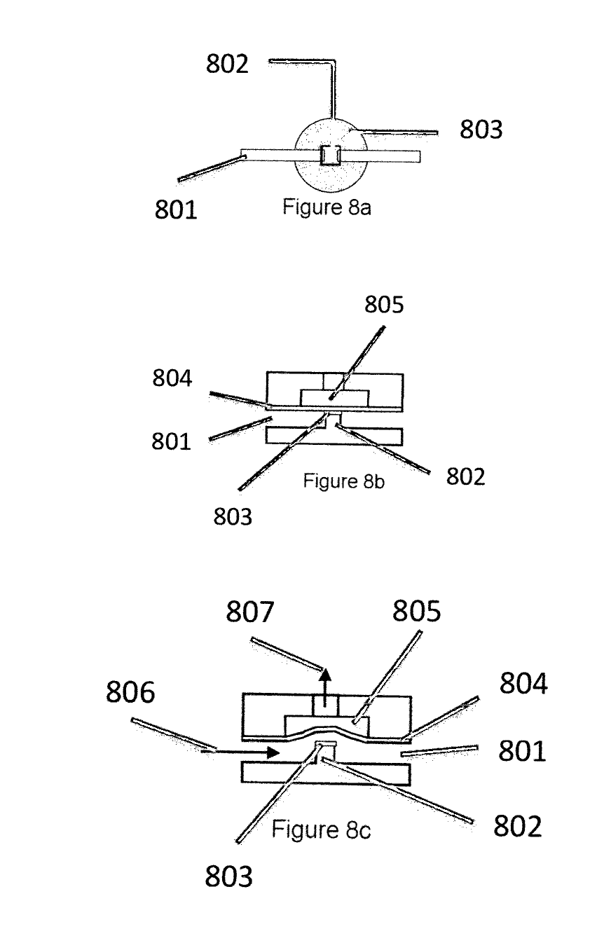

FIGS. 8a, 8b, and 8c illustrate a pressure relief or burst valve using one deformable layer. FIG. 8a represents the plan view of a channel 801 separated by a wall segment 802 with the bond-reducing material 803 printed to avoid bonding of the wall segment 802. FIG. 8b shows the side view perspective of the valve closed and the deformable layers 804 are in contact with the wall structure 802 having the printed layer 803. FIG. 8c illustrates when the valve is opened by an applied pressure 807 in the chamber 805 thereby enabling a variable flow control valve that can be actuated via pneumatic or hydraulic pressure separate to the microfluidic channel 801. FIG. 8c illustrates how a negative pressure 807 may be applied to the chamber 805 above the deforming layer 804 to help the movement of the deforming layer 804 off the wall structure 802, thereby enabling fluid flow 806 to pass through the microfluidic channel 801. Similarly a positive pressure can be applied to help ensure the valve is closed or provide a restrictive pressure to control the flow rate to the fluid in the channel.

In another embodiment of the invention a burst valve for storing and releasing reagents comprises a bond-reducing material. This effectively allows a seal to be formed in the microstructure at spatially predefined points, which may then remain sealed until an applied force is used to overcome the reduced bond strength at these predefined points. This invention enables an effective barrier layer to oxygen and water transmission until the burst valve is opened, which is critical for the long term storage and release of reagents.

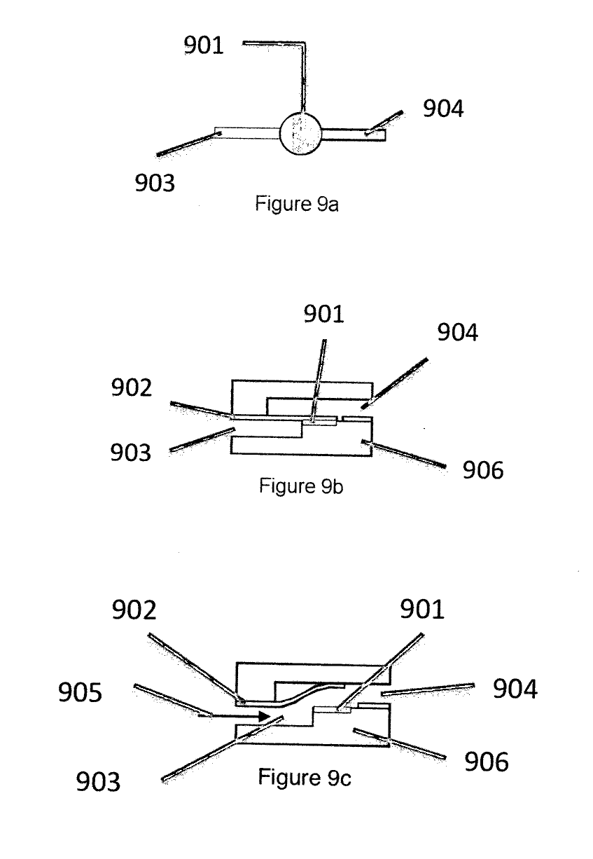

In another embodiment a valve structure comprises a bond-reducing material. FIG. 9 illustrates a bond-reducing material 901 used in a check, or one-way, valve. FIG. 9a represents the plan view and FIGS. 9b and 9c illustrate the side views with the valve closed and open, respectively. The bond-reducing material 901 ensures that the deforming layer 902 is not bonded to the substrate 906 in the vicinity of the valve structure. When the positive pressure difference between the microchannels 903 and 904 is large enough the deforming layer 902 deforms into the channel 904 and fluid 905 can flow from the channel 903 to channel 904. If there is a significant pressure in the reverse direction, between channels 904 to 903, then the deformable layer 902 is pressed against the substrate 906 preventing fluid flow in this direction.

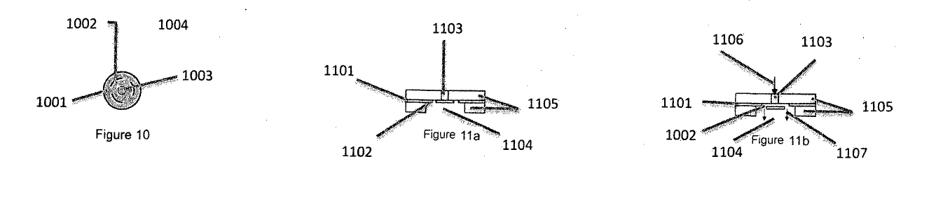

An alternative embodiment of a check, or one-way, valve is shown in FIG. 10 and FIG. 11 respectively. FIG. 10 represents the plan view of the substrate structure 1004 with through hole 1003 covered by a printed bond-reducing layer 1001 on a deformable layer with opening 1002. FIGS. 11a and 11b illustrate the side views of the same valve structure closed and open, respectively. The deforming layer 1101 contains a bond-reducing material printed on its surfaces in the vicinity of the valve to ensure that the deformable layer 1101 is not bonded to the substrate 1105 in the vicinity of the valve structure, and cuts 1102 through the deformable layer 1101 enable passage of fluid when the valve is open. When the positive pressure differential between the microchannels 1103 and 1104 is such that the deformable layer 1101 deforms into the channel 1104 then fluid can flow as shown by the arrows 1106 and 1107 from the channel 1103 to channel 1104 through the cuts 1102. If there is a significant pressure in the reverse direction, between channels 1104 to 1103, then the deformable layer 1101 is pressed against the substrate 1106 preventing fluid flow in this direction.

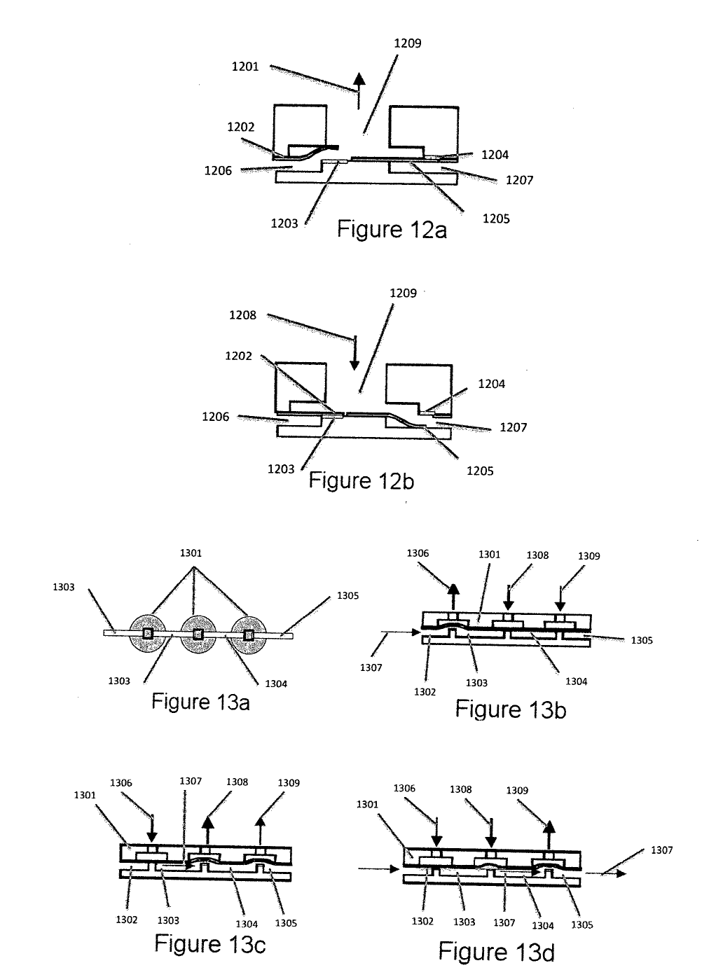

In another aspect of the invention it is advantageous to form complex fluid handling systems containing pump and or valve components. In one embodiment of the invention a microfluidic pump structure comprises a bond-reducing material. FIGS. 12 and 13 show examples of syringe and peristaltic type pumps respectively using bond-reducing materials. FIG. 12a illustrates the application of a negative pressure 1201 in the common pump chamber 1209 opening the inlet valve by lifting the deformable layer 1202 in the vicinity of the printed bond-reducing layer 1203 to enable fluid flow from the channel 1206 into the chamber 1209. Similarly FIG. 12b illustrates the application of positive pressure 1208 to the common pump chamber 1209 forcing fluid out the outlet valve by depressing the 1205 in the vicinity of the printed layer 1204 to enable fluid flow out through the channel 1207.

In another embodiment FIG. 13a illustrates the plan view of three valves 1301 of a similar type to FIG. 8 arranged in series connecting microchannels 1302, 1303, 1304 and 1305. By sequentially operating each of these valves a peristaltic type motion of the fluid can be obtained, as illustrated in FIGS. 13b, c and d. FIG. 13b illustrates a cross section view when a negative actuation force 1306 is applied to open the first valve and subsequent valves have positive actuation forces 1308,1309 applied to keep them closed. Fluid flow 1307 can then occur between channels 1302 and 1303. FIG. 13c illustrates a cross section view of the next state when negative actuation forces 1308, 1309 are applied to open the second and third valves and then a positive actuation force 1306 is applied to close the first valve. Fluid flow 1307 from force of closing the first valve can then occur between channels 1303 and 1304, with subsequent fluid displacement from 1304 to 1305. Similarly when FIG. 13d illustrates a cross section view of the next state when the second valve is closed by force 1308 whilst the first is held closed by 1306 and the third valve is open by 1309, this forces fluid 1307 from chambers 1304 to 1305. The cycle can then be repeated to continue the pumping motion.

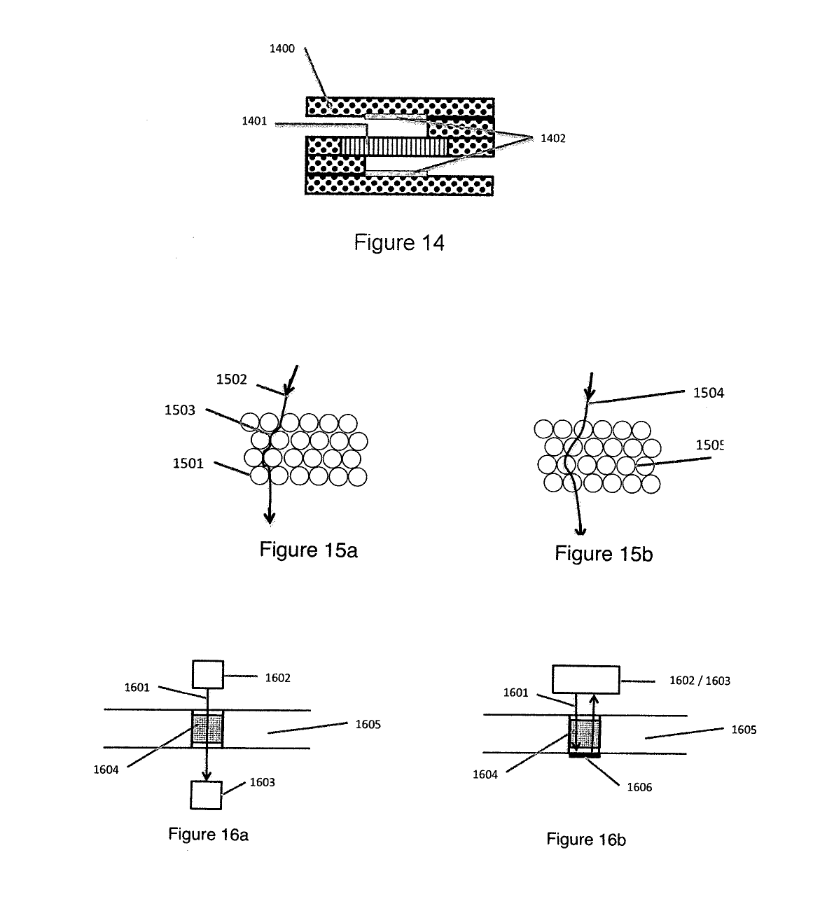

In another aspect of the invention the bond-reducing material is used to prevent bonding to parts of integrated components within a microfluidic device. This is particularly important where the materials used for both the microfluidic device structure and the integrated components are compatible with the bonding process. For example FIG. 14 shows a cross section of a section of a polyolefin microfluidic device 1400 containing an integrated filter or porous polyolefin component 1401. The bond-reducing material 1402 is coated above and below the portions of the filter where bonding is not required, thereby enabling fluid communication between the two channels via this portion of the filter.

In another embodiment of the invention a microfluidic device comprises any combination of pump and or valve components, wherein a bond-reducing material is used.

The invention overcomes the limitations described in the application of affinity chromatography by providing a planar substrate with discrete optical detection flow cells that contain porous material and have connecting microchannels for fluid delivery and/or removal, and a method for making the same.

The invention uses a porous material inserted into a planar substrate where the flow to or from the porous media is enabled by at least one connecting microchannel, and where there is an optical detection means for measuring an analyte in the porous network.

There are numerous advantages of this invention. These include:
An increase in assay sensitivity for assays involving surface binding due to the greater surface area available in the porous structure than for traditional microfluidic and well plate based analysis methods.
Faster reaction kinetics for assay reactions involving surface groups due to reagent flow through the porous network enabling a much closer proximity of the analytes to the surface groups.
Discrete detection flow cells that reduce cross talk between the optical detection sites due to their insertion into the substrate.
Improved flow characteristics for parallel structures due to the backpressure provided by the porous structure ensuring controlled flow distribution.
The capability to provide offline porous network preparation by batch methods prior to insertion into the substrate.

The invention enables simpler and lower cost manufacturing process to be employed where an otherwise smaller structure with smaller tolerances would be required to provide an equivalent microstructured flow cell. There are many commercially available colorimetric, absorption, fluorescence, and chemiluminescent chemicals available from many suppliers that may be used for optical detection in this invention. The porous optical flow cells can operate with a high sensitivity using either opaque or transparent porous materials. The optical light path through the porous network can be depicted by variations of the two cases shown in FIG. 15. FIG. 15a) illustrates an example of part of an optical detection cell of the present invention where the light 1502 traverses through the pores 1503 of the porous network 1501, whilst FIG. 15b) illustrates an example where the light path 1504 traverses through transparent porous material 1505.

The flow cells may be configured with optionally a source or detection optics, which can be located on opposing sides or the same side of the detection flow cell. No source system is required in the cases where chemiluminescence or other light generating assays are used. In one embodiment the source and detection systems are located on either side of the planar substrate. For example FIG. 16a shows the light path 1601 passing through the detection flow cell containing porous material 1604 in the substrate 1605 from the source system 1602 to the detector system 1603. In an alternative embodiment the source and detector systems are located on the same side of the substrate. For example FIG. 16b) depicts the light 1601 from the source system 1602 passing through the detection flow cell containing porous material 1604 in the substrate 1602 and is reflected by a combination of the porous material 1604 and or the reflective layer 1606 to the detector system 1603.

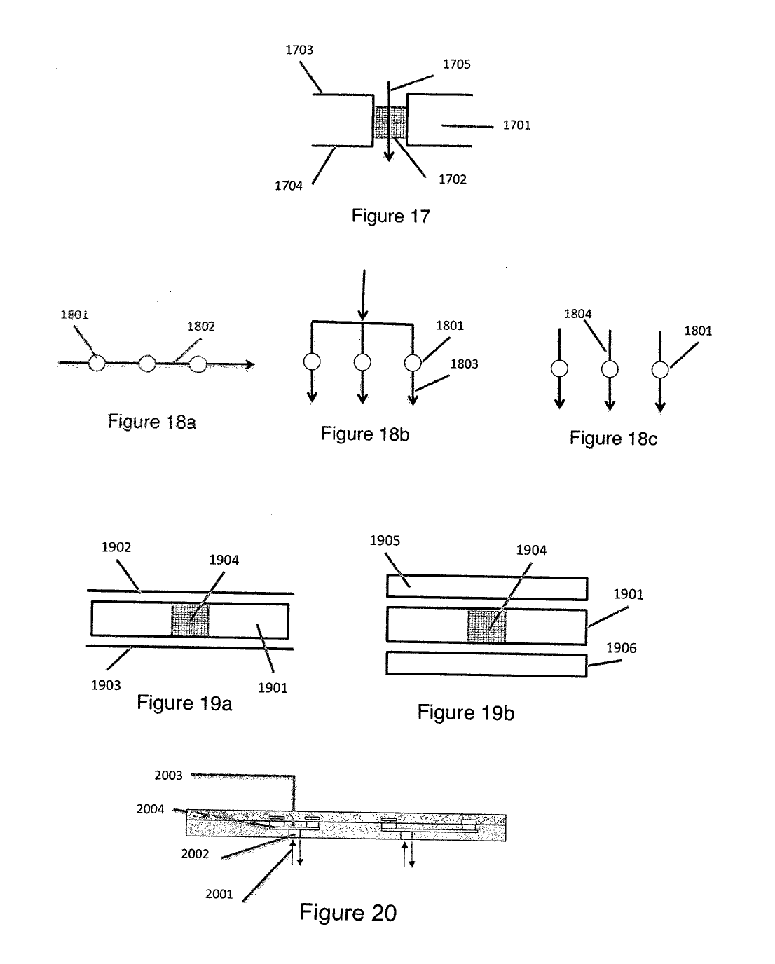

In a preferred embodiment the porous material is arranged so that the flow through the porous structure is perpendicular to substrates surface. FIG. 17 depicts the cross section of a substrate 1701 with a detection flow cell containing porous material 1702 with the direction of fluid flow through the detection cell 1702 indicated by the arrow 1705 perpendicular to the substrate surfaces 1703, 1704.

In a preferred embodiment of the invention a single substrate may have multiple detection flow cells containing porous material. Instances of where assays require detection of multiple reagents include but are not limited to the reading of multiple samples, multiple analytes in the same sample, the use of control samples, calibration factors, and the assay replicates or repeating the same tests. The multiple detection flow cells 1801 may be arranged with interconnecting microchannels in either series 1802 or parallel 1803 configurations, or arranged with microchannels having flows independent to one another 1804, as depicted in FIGS. 18a), 18b), and 18c) respectively. The microchannel configuration is made based on the assay, interfacing instrument, and user requirements. Example devices may be fabricated for point-of-care or laboratory applications with implementation ranging from small test cards the size of a postage stamp, through to industry standard formats such as microscope slides or microtiter plates.

In a preferred aspect of the invention a device for improving optical detection is provided by incorporating a porous material inside a detection flow cell to increase the surface area for binding. An example of this is the use of a porous material as a solid phase for the binding of analytes in affinity chromatography. In one embodiment the porous material may be a polymer, glass or ceramic filter that may or may not be surface modified to provide controlled surface chemistries for binding. Such polymers may include, but are not limited to, Cyclo Olefin Polymer; polypropylene; polyethylene; low density polyethylene; high density polyethylene; polymethyl-methacrylate; polycarbonate; polyethylene terephthalate; polyethylene terephtalate glycol; polybutylene terephtalate; polystyrene; polyimide; polyetherimide; acrylonitrile butadiene styrene; polyurethane; polydimethylsiloxane; cellulose acetate; polyamide; polyether ether ketone; polyvinylchloride; polyvinylidene chloride; polyvinylidene fluoride; polymethylpentene; polysulfone; polytetrafluoroethylene; polyoxide methylene; nitrocellulose, nylons, acrylics, acetates, polyacrylamides, latex or silica particles, glass fibres or combinations thereof.

In one embodiment, alteration of the surface chemistry or the binding of surface coatings to the porous materials may be performed by a batch based process before they are inserted into the card. In an alternative embodiment, alteration of the surface chemistry or the binding of surface coatings to the porous materials may be performed after the card is manufactured by using a flow through protocol as described herein.

In one embodiment a surface activation step is used to activate the surface of the porous material. Surface activation involves altering the chemical groups present on the surface and the result is dependent on both the substrate and activation method. Examples of common chemical bond modifications include amine, carboxylic acid, and hydroxyl species. Industry standard methods for surface modification include corona discharge, wet chemical modification, plasmas using a variety of gases such as argon, oxygen, nitrogen, ethylene oxide, ammonia, acetone, methanol, and ethylenediamine.

In one embodiment the surface coating on the porous material is a multi-layer coating. The attachment of the layers can be covalent, electrostatic, or caused by physical entrapment and are well known to people skilled in the art of biochemistry and surface treatment. Examples of such layers include materials that contain an overall or localized charge (cationic or anionic), or are able to provide these charges when attached to a substrate or another coating, small molecules such as salts, biomolecules, neutral and charged polymers or polyelectrolytes, ligands, surfactants, and combinations thereof. Many types of polymers are often used to directly adhere to a surface.

In a one embodiment, one or more surface coating layers may include any of; surfactant, cationic surfactants, anionic surfactants, amphoteric surfactants, and fluorine containing surfactants, phosphate, polyethylenimine (PEI), poly(vinylimidazoline), quaternized polyacrylamide, polyvinylpyridine, poly(vinylpyrrolidone), polyvinylamines, polyallylamines, chitosan, polylysine, poly(acrylate trialkyl ammonia salt ester), cellulose, poly(acrylic acid) (PAA), polymethylacrylic acid, poly(styrenesulfonic acid), poly(vinylsulfonic acid), poly(toluene sulfonic acid), poly(methyl vinyl ether-alt-maleic acid), poly(glutamic acid), dextran sulfate, hyaluric acid, heparin, alginic acid, adipic acid, chemical dye, protein, enzyme, proteins, enzymes, lipids, hormones, peptides, nucleic acids, oligonucleic acids, DNA, RNA, sugars, and polysaccharides, immunoglobulins G (IgGs) and albumins, such as bovine serum albumin (BSA) and human serum albumin, peptide, isocyannated terminated polymers, including polyurethane, and poly(ethylene glycol) (PEG); epoxy-terminated polymers, including PEG and polysiloxanes; and hydroxylsuccimide terminated polymers. or a salt or ester thereof.

In one embodiment a layer of either Biotin or PEG can be coated to a porous material, where the porous material has a charged surface opposite to that of the functional group on the PEG or Biotin molecules. In another embodiment a layer of biomolecules such as proteins, enzymes, peptides, DNA, or RNA are electrostatically attached to the surface of the porous material.

The porous material is inserted into the substrate during the card assembly process. Adhesives or localised melting at the interface of the filter to the surrounding material may be used to affect a seal along the filter edges. In one preferred embodiment a pressure fit is used where the filter is compressed into a hole that is smaller in diameter than the filter. This compression fit requires no adhesive and ensures no fluid leaks around the edges of the filter material.

The substrate may be made of any suitable polymer such as: polyolefins; Cyclo Olefin Polymer; polypropylene; polyethylene; low density polyethylene; high density polyethylene; polymethyl-methacrylate; polycarbonate; polyethylene terephthalate; polyethylene terephtalate glycol; polybutylene terephtalate; polystyrene; polyimide; polyetherimide; acrylonitrile butadiene styrene; polyurethane; polydimethylsiloxane; cellulose acetate; polyamide; polyether ether ketone; polyvinylchloride; polyvinylidene chloride; polyvinylidene fluoride; polymethylpentene; polysulfone; polytetrafluoroethylene; polyoxide methylene; nitrocellulose, nylons, acrylics, acetates, polyacrylamides, latex or silica particles, glass fibres or combinations thereof.

The microfluidic channels may be formed in the substrate, or formed in an attached layer connected to the substrate FIG. 19a) depicts a cross section of thin laminate sealing layers 1902, 1903 and the substrate 1901 with the porous material 1904 prior to assembly. In some embodiments the thin laminate layers 1902, 1903 may be used to create a seal with the substrate 1901. In one embodiment the device has a multi-layer laminate composition comprising microfluidic structures. For example the thin sealing layers 1902, 1903 may be formed from multilayer laminate materials that contain microchannels as described in WO 2007/085043, the entire contents of which are incorporated herein by reference.

FIG. 19b) depicts a cross section of sealing layers 1905, 1906 and the substrate 1901 with the porous material 1904 prior to assembly. In some embodiments the substrate 1901 or sealing layers 1905, 1906 contain microchannels which may be formed by methods including, but not limited to, micromilling, laser based lithography and beam scanning, plasma etching, wet chemical UV lithography using photoresists, soft lithography, x-ray lithography, print-head deposition, soft lithography, stamping, embossing, compression molding, thermoforming, injection molding and reaction injection molding.

For many microfluidic applications it is advantageous to control the pumping, valving, or debubbling in these microfluidic devices. Examples of the constructions of components to perform these operations are described in WO 2007/060523, the entire contents of which are incorporated herein by reference. An example implementation is depicted in FIG. 20 where a pneumatic actuation force 2001 may be provided to common ports 2002 on the card and then distributed to the inlet or valve locations 2004 by pneumatic microchannels 2003 within the card.

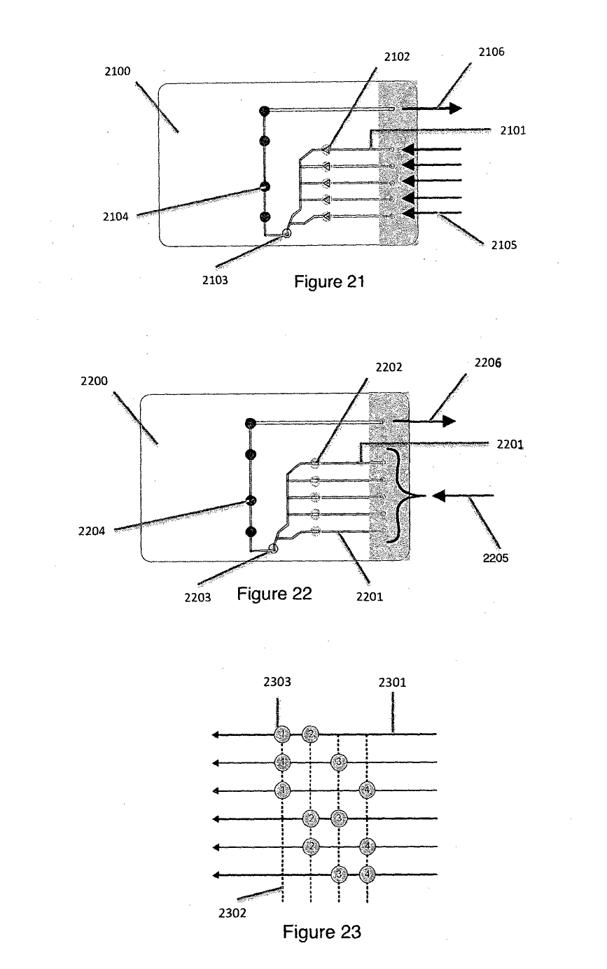

In one embodiment of the invention a device comprises multiple inlet microchannels with on-way valves, and/or a debubbler, and/or at least one detection flow cell, wherein optionally microfluidic flow control is provided by independently controlled fluid lines external to the device. For example, the device of FIG. 21 depicts a device 2100 that contains five inlet channels 2101 with one-way check valves 2102 connected to a debubbler 2103 and subsequent detection cells 2204 and common exit port 2106. The pressure 2105 is varied for each channel 2101 to control the flow in each separate channel and therefore the timing and volumes of fluids delivered to the detection cells 2104. One-way check valves 2102 are used to stop the backflow of fluid from one inlet channel to the other.

The method of using flow control valves valve control to adjust the flow rate from a single source is particularly advantages for cost and size reduction of the external instrumentation by reducing the number of pump and valve components required for complex devices.

In one embodiment of the invention the device comprises multiple inlet microchannels with variable flow valves, and/or a debubbler, and/or at least one detection flow cell, wherein optionally a pressure source external to the device provides pressure driven flow which is varied by the flow control valves. For example FIG. 22 depicts a device 2200 with common pressure source 2205 applied to some or all of the fluids passing through the inlet ports where the flow is controlled in the individual channels 2201 by external actuation of active flow control valves 2202 similar to those as illustrated in FIG. 8 to adjust the flow in each channel. In this example external pneumatic control of the Flow control valves 2202 would provide flow control from either a positive pressure at 2205 or a negative pressure applied to the common exit port 2206. A debubbler 2203 prevents air bubbles passing through to the detection cells 2204.

In one embodiment of the invention a device comprises onboard reagents, and/or microchannels with variable flow valves, and/or a debubbler, and/or at least one detection flow cell, wherein optionally a pressure source external to the device provides pressure driven flow which is varied by the flow control valves. For example, FIG. 23 illustrates the pneumatic actuation of 6 fluid channels 2301 with only four pneumatic lines 2302 by using multiple valves 2303 per line. In this manner each channel 2301 can be controlled separately because each channel 2301 has two valves 2303 for flow control. This ensures that when one channel 2301 is in use each other channel 2301 has at least one pneumatic line 2302 that is separate to the controlling line of the activated channel to independently control flow. Using more valves 2303 per line will further increase the number of separately controllable fluid channels 2301. Likewise more pneumatic lines 2302 greatly increases the valve 2303 combinations and therefore the number of independently controlled fluid channels 2301. For example 6 pneumatic ports would allow 15 independently controllable channels 2301 using only two valves 2303 per channel.

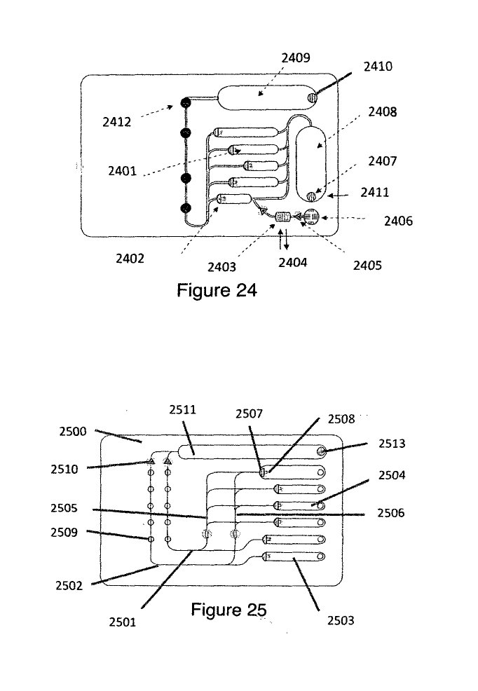

In another example a microfluidic card comprises components for reagent storage, and/or mixing or rehydration, and/or a debubbler, and/or controlled dosing, and/or Flow control and passive valves, and/or at least one detection flow cell containing porous material. These fluid handling components can be reconfigured on different cards to provide for the needs of different assays. Such assays include, but are not limited to: immunoassays such as the indirect, sandwich, competitive, and reverse ELISA methods. In the example of FIG. 24 the device 2400 enables a controlled dose of the sample to be injected into the Sample mixing chamber 2403 by the syringe style pump 2404 of the sample chamber 2403 sampling an aliquot of sample through the sample filter 2406. The sample mixing chamber may also contain reagents, such as cell lysis material, for mixing with the sample. The reagents would be rehydrated and sample mixed when the water is pumped from the water chamber 2408 from an applied pressure 2411. With the combined debubblers with Flow control valves 2402 closed at the ends of the reagent chambers 2401, the water will enter the chambers displacing the air through the debubbler vents 2402 until all the chambers 2401 are filled. The rehydrated and mixed reagent can then be individually controlled to flow through the detection cells 2412 and out to the waste storage 2409 with venting structure 2410. The detection cells 2412 may be analysed by optical detection means on the device 2400 and or with the use of external instrumentation.

The reagent storage can be either in liquid or dried format. In one embodiment dried lyophilised reagents are placed into the reagent and reconstitution chambers and water is stored or added through the water chamber.

For shelf life and stability considerations it is often advantageous in diagnostic applications to provide the reagents in a dried format. Dried reagents and processes of lypholizing are commonly known to those skilled in the art. Methods of lypholization by cryogenic methods are described in U.S. Pat. Nos. 3,721,725, 3,932,943, 4,848,094, 4,655,047. Whilst U.S. Pat. Nos. 4,820,627, 4,678,812, 4,762,857 and 4,115,537 describe processes suitable for preparing particles for tableting into diagnostic reagents.

As an example of the preparation of a freeze dried sample a stock solution made to one litre with distilled water containing the following; 0.5 mg of detection antibody, 25.5 g Sodium Chloride as a stabiliser, 3 g Triton X-100 as a surfactant to control bubble formation during dissolution, 71.5 g HEPES as a zwitterionic organic chemical buffering agent, and 84 g polyethylene glycol (MW 20,000) to facilitate formation of the matrix structure during freeze drying and for the development of turbidity during analysis. The freezing process is well known to those skilled in the art, as an example the droplets are dispensed into a cryogenic liquid. The rehydration of these freeze dried reagent droplets can be achieved with approximately 10 microliters of a 14:1 ratio mixture of water and human serum.

In one embodiment of the invention a method for performing a an immunoassay comprising the steps of: a) cross-linking a primary antibody to functional group on the porous materials surface; f) blocking non-specific antibody binding sites; g) incubating a sample containing a protein specific for the primary antibody; h) adding a detection antibody; and i) detecting the detection antibody.

In one embodiment the surface activation and binding of the porous material may be performed in a protocol after the cartridge has been assembled. For example such a procedure may involve the following steps: i) flowing 100 μl of 100% ethanol at 25 μl/min; ii) flowing 100 μl of a 1:1 mix of ethanol and distilled water at 25 μl/min; iii) flowing 100 μl of distilled water at 25 μl/min; iv) flowing 100 μl of carbonate buffer (pH=9.5) at 25 μl/min; v) incubating 20 μl of capture antibody for 45 mins in the detection cell; vi) washing with 250 μl of blocking buffer (0.1% BSA) at 25 μl/min,

In one embodiment the surface activation and binding of the porous material may be performed in a batch based protocol before the cartridge has been assembled. For example such a procedure may involve performing the following steps with the filters completely immersed in a stirred solution at room temperature: i) 100% ethanol for 10 minutes; ii) 1:1 mix of ethanol and distilled water for 10 minutes; iii) distilled water for 10 minutes; iv) carbonate buffer (pH=9.5) for 10 minutes v) incubating 20 μg/ml of capture antibody per filter for 45 mins; vi) blocking buffer (0.1% BSA) for 10 minutes,

In one embodiment the protocol for detecting Botulism toxin involves preparing the porous material (sintered HDPE particles giving an average pore size of <20 micron and a porosity of approximately 40%) by one of the flow through or batch based methods described above. Then performing the following flow based assay through the detection flow cells and analysing the result either visually or with a simple photodiode and LED source detection system. The flow based detection assay involves i) washing with 50 μl carbonate buffer (pH=9.5) at 25 μl/min; ii) introducing 100 μl of sample at 25 μl/min; iii) addition of 100 μl Biotinylated anti-BotA at 25 μl/min; iv) addition of 100 μl Streptavidin-polyHRP at 25 μl/min; v) washing with 50 μl carbonate buffer (pH=9.5) at 25 μl/min; vi) addition of 100 μl TMBN substrate at 25 μl/min with concurrent detection.

In one embodiment a card is provided that contains reagent reservoirs and or interfaces to headers that contain fluid reservoirs. These reservoirs can be filled prior to or after insertion of the card into an instrument that contains the detection and or pneumatic interface. The example of FIG. 25 shows a dual channel card 2500 where each of the channels 2501, 2502 has a separate reservoir 2503 and four common reservoirs 2504. In this example all the channels in the direction of 2501, 2502 are on different layers to all the channels 2505, 2506. Debubblers 2507 enable the release of air from the reservoirs upon filling and emptying of the reservoir chambers 2503, 2504. Flow control valves 2508 are controlled to restrict or release the flow of fluid according to the actuation control. The detection chambers 2509 may include filters for enhanced binding and one-way check valves 2510 are used to prevent backflow from the waste 2511 into the detection chambers 2509. A final vent 2513 is provided in the waste chamber to release air and prevent leakage of fluid from the card structure.

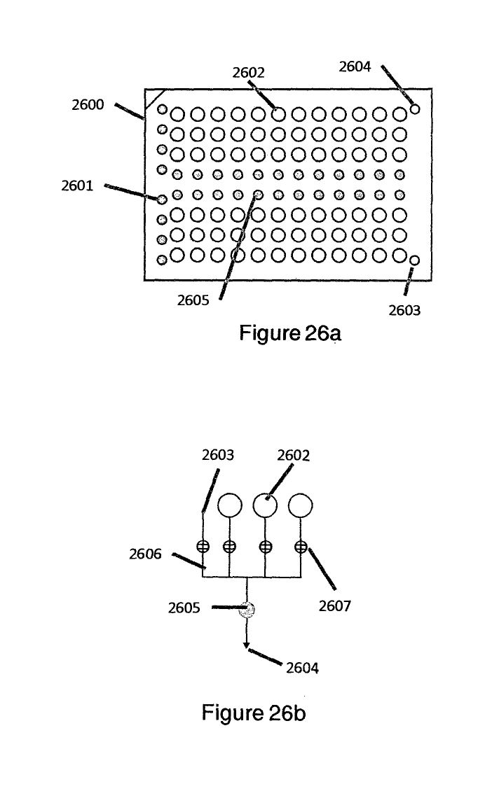

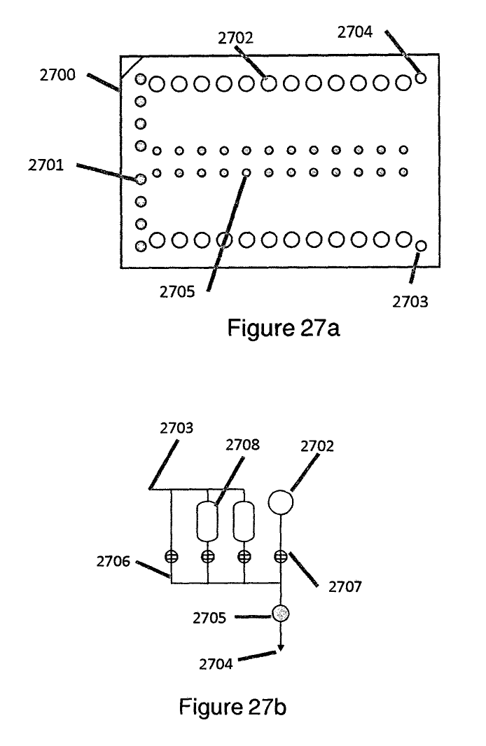

In one embodiment the microfluidic device has a size and detector flow cell layout compatible with standard microtiter plate based systems (ANSI/SBS 1-2004: Microplates; ANSI/SBS 2-2004: Microplates; ANSI/SBS 3-2004: Microplates; ANSI/SBS 4-2004: Microplates). For example FIG. 26a depicts the top view of a twenty four circuit microfluidic card 2600 with detection flow cells 2605 and reagent inlet ports 2602 having a substantially similar spacing to a 96 microtiter plate. The instrument interfaces through the pneumatic control ports 2601 to provide control over the Flow control valves, with fluid ports 2603, 2604 providing buffer and waste line connections. FIG. 26b illustrates one embodiment of the microfluidic diagram for each equivalent microfluidic circuit associated with each detection flow cell containing porous material 2605. Three reagent reservoirs 2602 and a common wash buffer source 2603 are connected to the detection flow cell containing porous material 2605 via microfluidic channels 2606 and Flow control valves 2607. The three ports 2602 enables the user to add an independent set of reagents to each detection flow cell containing porous material 2605. Negative pressure supplied from the instrument through the waste line 2604 draws the reagents through when the valves 2607 are opened. More than one Flow control valve 2607 may also be used on each channel where the pneumatic control lines are multiplexed to many microfluidic channels, as illustrated in FIG. 23.

In an alternative embodiment the microfluidic device has a size and detection flow cell layout compatible with standard microtiter plate based systems and incorporates on-board reagents. For example FIG. 27a depicts the top view of a twenty four circuit microfluidic card 2700 with detection flow cells 2705 and reagent inlet ports 2702 having a substantially similar spacing to a 96 microtiter plate. The instrument interfaces through the pneumatic control ports 2701 to provide control over the Flow control valves, with fluid ports 2703, 2704 providing buffer and waste line connections. FIG. 26b illustrates one embodiment of the microfluidic diagram for each equivalent microfluidic circuit associated with each detection flow cell containing porous material 2705. One reagent reservoir 2702 is provided for external addition of reagents. The two internal reagent reservoirs 2708 contain dried reagent that rehydrates with the addition of buffer from the common buffer source 2703. These reservoirs 2702, 2708 and the common buffer line 2703 are connected to the detection flow cell containing porous material via microfluidic channels 2706 and Flow control valves 2707 which may comprise debubbler components. The three ports 2702 enable the user to add an independent set of reagents to each detection flow cell containing porous material 2705. Negative pressure supplied from the instrument through the waste line 2704 draws the reagents through when the valves 2707 are opened. More than one Flow control valve 2707 may also be used on each channel where the pneumatic control lines are multiplexed to many microfluidic channels, as illustrated in FIG. 23.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

The reference to any prior art in this specification is not, and should not be taken as, an acknowledgement or any form of suggestion that the prior art forms part of the common general knowledge.

1. A method for forming a spatially defined bond between a first surface and a second surface, the method comprising the steps of (i) printing a bond-reducing material to an area on the first surface, and (ii) contacting the first surface and the second surface under conditions allowing the first surface to bond to the second surface, wherein the bond-reducing material substantially prevents or otherwise interferes with the formation of a bond between the first surface and the second surface about the area to which the bond-reducing material is applied, wherein the structure resulting from bonding first surface and the second surface is a microfluidic device.

2. A method according to claim 1 wherein the bond-reducing material is printed by a process selected from the group consisting of: contact Microspotting or non-contact microspotting; Contact printing; Screen printing; Syringe delivery; ink-jet delivery; Lithography; robotic placement of dried or liquid chemicals;
Letterpress, Gravure, flexographic and other such printing methods; contact mask based deposition methods; Laser based deposition; laser based surface modification techniques; and
thermal transfer methods, such as with laser, hot stamping, and thermal ribbon printers.

3. A method according to claim 1 wherein the bond-reducing material is an ink comprising i) colorants that provide colour contrast, ii) vehicles or varnishes that bind to the printed surface, iii) additives that influence the printability, film characteristics, drying speed, or end-use properties and optionally include chemical moieties for bond reduction, and iv) one or more solvents to expedite formation of the vehicles, reduce ink viscosity, adjust drying properties of the ink, or resin compatibility of the ink.

4. A method according to claim 1 wherein the bond-reducing material is a solid film or foil, powder, high-viscosity paste, gel, or a low-viscosity liquid.

5. A method according to claim 1 wherein the first surface is bonded to the second surface by a method selected from the group consisting of laser welding, diffusion bonding, surface modified chemical bonding, solvent assisted bonding, thermal laminating, chemical covalent or charged surface group bonding, mechanical interlocking, ultrasonic welding, die-electric bonding, microwave bonding, electrostatic attraction, magnetic attraction, and adhesive bonding.

6. A method according to claim 1 wherein the bond-reducing material is at least partially removed prior to or after the first surface is bonded to the second surface.

7. A method according to claim 1 wherein the bond-reducing material is at least partially removed by a method selected from the group consisting of evaporation, absorption, chemical reaction or the application of mechanical force, air or liquid pressure.

8. A composite structure formed by the spatially-selective bonding a first structure to a second structure, the composite structure having in one area a cross-sectional arrangement comprising the first structure, a bond-reducing material, and the second structure; and in another area the first structure, a bond-forming material and the second structure.

9. A composite structure according to claim 7 wherein the first structure or the second structure are materials selected from the group consisting of: polyolefin; Cyclo Olefin Polymer; polypropylene; polyethylene; low density polyethylene; high density polyethylene; polymethy!-methacrylate; polycarbonate; polyethylene terephthalate; polyethylene terephtalate glycol; polybutylene terephtalate; polystyrene; polyimide; polyetherimide; acrylonitrile butadiene styrene; polyurethane; polydimethylsiloxane; cellulose acetate; polyamide; polyether ether ketone; polyvinylchloride; polyvinylidene chloride; polyvinylidene fluoride; polymethylpentene; polysulfone; polytetrafluoroethylene; polyoxide methylene; nitrocellulose, nylons, acrylics, acetates, polyacrylamides, latex particles, or silica particles, and glass fibres, or combinations thereof.

10. A composite structure produced by a method according to claim 1.

11. A microfluidic device comprising a composite structure according to claim 8.

12. A substantially planar microfluidic device for the affinity chromotographic analysis of a liquid analyte, the device comprising a substantially larger detection flow cell than the connecting microfluidic channels, the detection flow cell disposed substantially perpendicular to the plane of the device, the flow cell comprising (i) a liquid entry aperture (ii) a porous region and (iii) a liquid exit aperture, wherein in use the analyte flows from the liquid entry aperture, through the porous region and exits the flow cell via the liquid exit aperture.

13. A device according to claim 12 wherein the substantially larger detection flow cell is disposed at an angle ranging from 45 to 90 degrees relative to the plane of the device.

14. A device according to claim 12 wherein the substantially larger detection flow cell is disposed at an angle of about 90 degrees relative to the plane of the device.

15. A device according to claim 12 wherein the detection flow cell is capable of sustaining a maximum flow rate of 1000 micro litres per minute; optionally wherein the detection flow cell has a length of 10 micron to 10 millimetres, optionally wherein the detection flow cell has a width of 100 micron to 10 millimetres.

16.-24. (canceled)

25. A device according to claim 12 wherein the detection flow cell is substantially cylindrical or rectangular shaped; optionally wherein the detection flow cell comprises a polymer frit; optionally wherein the detection flow cell comprises an affinity ligand.

26. A device according to claim 12 wherein the detection flow cell comprises an affinity chromatographic resin.

27. A device according to claim 12 having a size and detection flow cell layout compatible with standard microtiter plate based systems.

28. A device according to claim 12 having a multi-layer laminate comprising microfluidic structures.

29. A microfluidic affinity chromatographic method, the method comprising (i) introducing an analyte into the detection flow cell of a device according to claim 1 under conditions allowing the binding of a target molecule in the analyte to an affinity ligand and (ii) detecting the presence or absence of a bound target molecule.
